(19) United States
(12) Patent Application Publication
(10) Pub. No.: US 2003/0163740 A1
(43) Pub. Date: Aug. 28, 2003

(54) User interface system

(76) Inventors: Phin Thjai, Sydbey (AU); Simon carmody, Sydney (AU)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/204,202

(22) PCT Filed: Feb. 15, 2001
(86) PCT No.: PCT/AU01/00109

(30) Foreign Application Priority Data
Feb. 15, 2000 (AU) PQ 5639
Feb. 15, 2000 (AU) PQ 5640

(51) Int. Cl. H04L 9/00

(52) U.S. Cl. 713/202

(57) ABSTRACT

The present invention relates to a user interface system for interfacing a user with a plurality of vendor servers over a computer network. The system enables a computer user to create a plurality of “virtual” connections to secure vendor servers serving up content which requires some level of security to enable access to the content. The computer user provides the password necessary for access to the content to the interface system. The interface system stores these passwords. When the user wishes to make a connection, they connect to the interface system, the passwords are validated by the interface system and content is subsequently served to the user from the vendor servers.

### FIELD OF THE INVENTION

The present invention relates broadly to a user interface system for interfacing a user with a plurality of vendor servers over a computer network. The present invention will be described herein with reference to a content server for a plurality of stock broker's web sites. However, it will be appreciated that the invention does have broader applications and is not limited to a specific content of the plurality of vendor servers.

### BACKGROUND OF THE INVENTION

A large number of vendor servers provided eg. on the Internet can be accessed by a user (utilising an Internet browser) only through a login process, because of protocol requirements for the connection to those vendor servers. For example, the vendor may be providing private content and therefore security is required in order to identify the user. Identification of the user may also be required in order to ascertain a level of security access for the user to the information being provided by the vendor. The term “vendor servers” is not intended to be limited to any particular server, but rather to include any server from which eg. information, goods, or services can be provided to the user.

Because of the necessity for the login process, the connection between the user's browser and the vendor's server is typically referred to as a one-to-one connection. However, this means that authentication takes place on the server side before the connection is established, and once the connection is established, a further application must be executed before the user may connect to a different server. Thus connecting to a plurality of such vendor servers is a somewhat cumbersome exercise. This is particularly disadvantageous where the information is required in real time from different vendor servers.

It is known to provide content “warehouses”. These collate and store information provided to them by different vendors. The user can access the content warehouse server in order to obtain access to the collated content. A major problem with content warehouses, however, is that they often don't contain all the information which is available by accessing the vendor servers directly. Further, functionality available by directly accessing the vendor server is not available at the content warehouse server. Further, the information at the content warehouse may not be as “real-time” as it has to be processed and collated before it can be released. From the vendor's point of view, there is no control over access to the vendor's information, apart from the vendor's control over the information they decide to send to the warehouse.

There is a need for an interface system and process which enables a user to interface with a plurality of vendor servers in a convenient manner.

Where a user is connected to a vendor server, the vendor may often require the user to be connected for a predetermined time period only. This is to prevent the connection being maintained when the user is perhaps no longer viewing it (they may have left their computer on by mistake, for example), and to minimise the chance of unauthorised access. To maintain the connection, the user may have to go through a further login process.

Typically, after a successful initial login process the vendor server labels the user's browser with a time cookie. After expiry of the time identified by the time cookie, a “maintenance” login request will be initiated by the vendor server. Before the user is able to continue his utilisation of the vendor server, he will be required to respond to the maintenance login request. Importantly, the vendor server effectively freezes for the user until the maintenance login request has been successfully responded to.

This maintenance requirement adversely affects the convenience with which a user can access e.g. information from the server.

There is a need for a system and process which facilitates maintaining a connection to a vendor server.

### SUMMARY OF THE INVENTION

It will be appreciated by a person skilled in the art that the terms “connecting” or “connection” etc. used in the claims and throughout the specification are intended to refer generically to the opening of a session with a particular server. Furthermore, the term “login” is intended to refer generically to an authentication process enabling the establishment or maintenance of a session.

In accordance with a first aspect of the present invention there is provided a user interface system for interfacing a user with a plurality of vendor servers on a computer network, wherein a connection to each of the vendor servers is establishable via a protocol involving a login process, the system comprising first login means for allowing access to the system by the user; means for storing further login information, the further login information comprising a plurality of passwords for associated ones of the plurality of servers; and means for automatically establishing connections between the user and the associated ones of the plurality of servers based on the stored login information.

Accordingly, the system can establish a plurality of virtual one-to-one connections between the user and the associated servers notwithstanding that each of the servers can only be accessed via a protocol involving a login process.

Note that a “password” may include any means of identifying the user to the server and may include a PIN, fingerprint identification, a combination of words and numbers, retinal identification, or any other means of identification.

The login means may be arranged to allow access to the system via a browser utility for the computer network. The network may comprise the Internet.

The system may further comprise means for authenticating the plurality of passwords on the basis of authentication data stored in a database of the system.

The means for authenticating may comprise means for encoding each of the passwords for comparison with associated encoded authentication data stored in the database of the system.

The system may further comprise means for receiving the authentication data from the servers for storage in the database. The means for receiving the authentication data may be arranged to encode uncoded authentication data received from the servers and to store the encoded authentication data in the database.

The means for storing the plurality of passwords is preferably a further database. The passwords are preferably stored associated with user identifier data of the user in a manner such they are available to the system when access to the system is allowed by the login means.

Preferably, the system is arranged to store the plurality of passwords in the encoded form.

At least preferred embodiments of the present invention can provide a centralised authentication for the plurality of associated servers. This may be achieved without the necessity to centralise administration and maintenance of security policies of the servers. This means that each server can maintain and administer its own security policies and rules in their relationship with the system and the users, which is one of the foundations of a solid security system.

Furthermore, the fact that in one embodiment the authentication data is stored and processed in an encoded form can improve the security of the system by not providing a “transparent” database.

The user interface system is preferably a server computing system (termed “content server”). The user preferably accesses the content server via a client computing system and browser.

In one embodiment, the connection between the-user and the vendor server(s) is established by the user interface system via browser-based authentication. Preferably, to implement browser-based authentication, the content server sends a requested URL (e.g for a document that a client requires from a vendor server) back to the client's browser, which then establishes a connection directly with the vendor server if it is hosting the requested URL address. The client's browser is authenticated to the content server which serves the metadata (URL) to the client's browser. In this embodiment, the content server requires the authentication means discussed above and the authentication data from the vendor server.

Some URLs arise from secure servers and merely providing a URL address to a client's browser (following content server authenticating the client's browser) will not be sufficient to enable the client to access the secure server document. In these circumstances, content server preferably achieves seamless authentication for the client by appending the client's password for the particular vendor server to the URL address and then passing the URL string back to the client's browser. The client's browser then passes the URL string to the secure server to retrieve the requested document. Preferably, the URL string is encrypted before being passed back to the client's browser (so that the password remains secure).

It will be appreciated that a URL (universal resource locater) is one form of access means, particularly for use with the Internet, to enable retrieval of documents being served by computer systems connected on the Internet. It will be appreciated that the present invention is not limited to application on the Internet, and the term URL, in this document, should be taken to mean any access means which enables a connection to a computer system, preferably to receive a document or other item from the computer system or to connect to the remote computer system.

In the above embodiment, the client's browser is connected directly to receive documents from the vendor server. This browser-based authentication is dependent upon the client's infrastructure (firewall and proxy server) permitting the content server-generated URL string (containing the client's password) to be successfully passed through to the secure server.

In some cases, dependent upon the client's infrastructure, the content server-generated URL string may not be successfully passed to the client. The client will then not be authenticated on the secure server and the user will be prompted for their authentication details.

In a further embodiment, to avoid this problem, the user interface system implements “server based authentication”.

Server-based authentication on content server works by the content server taking the client's request for a document (from a particular vendor server) then acting as the client itself by issuing its own request (on behalf of the client) to the server destination where the document is stored. The content server downloads the document and then serves the document back to the original client machine.

In a further embodiment of the present invention, browser based and server based authentication may be combined. They may be combined to deliver different “types” of content to the user e.g. content that is directly from the vendor server (browser-based authentication) and content which is from a vendor server by way of the user interface system (server-based authentication). These different types of content may be delivered to the same page viewable by the user, being seamlessly served up to the client in the same page.

For example, for simple “document” types of content, server-based authentication provides fast effective delivery to the client. More complex types of content, such as pages, or page sections, composed of URLs relating to models and databases located on the vendor server secure site, may be more simply and effectively handled by browser-based authentication. This is because the user will be able to gain most value by direct interaction with the functionality of the vendor server secure site, which in turn requires the client to establish a direct session with the secure vendor server.

As discussed above in the preamble, vendor servers may from time to time require the user to respond to a maintenance login request in order to enable the connection to the vendor server to be maintained. Preferably, the user interface system of the present invention includes maintenance means for automatically responding to the maintenance login request initiated by a vendor server after a period of connection time, wherein the maintenance means is arranged to base the response to the maintenance request on the stored login information.

Accordingly, the system can preferably facilitate an “uninterrupted” connection between the user and the vendor server. Where the system is arranged to maintain a plurality of connections of the user to a plurality of vendor servers, the maintenance means is arranged to respond to a plurality of maintenance login requests initiated by the servers after associated periods of connection time without user interaction.

In accordance with a second aspect of the present invention, there is provided a method of interfacing a user with a plurality of vendor servers on a computer network, wherein a connection to each of the vendor servers is establishable via a protocol involving a login process, comprising the steps of providing a user interface service, the user interface service requiring a first login password to enable a user to access the service, storing further login information by the user interface service, the further login information comprising a plurality of passwords for associated ones of the plurality of servers, and establishing connections between the user and the associated ones of the plurality of the servers based on the stored login information.

In accordance with a third aspect of the present invention there is provided a computer program element including computer program code means arranged to instruct a computer to operate as a user interface system for interfacing the user with a plurality of vendor servers on a computer network, where a connection to each of the vendor servers is establishable via a protocol involving a login process, a computer program code means instructing the computer to allow access to the system by the user through a first login means, to store further login information, the further login information comprising a plurality of passwords for associated ones of the plurality of servers, and establish connections between the system and the associated ones of the plurality of servers based on the stored login information.

In accordance with a fourth aspect of the present invention there is provided a computer readable medium having instructions recorded thereon for instructing a computer to operate as a user interface system for interfacing a user with a plurality of vendor servers on a computer network, where a connection to each of the servers is establishable via a protocol involving a login process, the instructions being arranged to instruct the computer to allow access to the user interface system by the user through a login means, to store further login information, the further login information comprising a plurality of passwords for associated ones of the plurality of servers, and to establish connections between the system and the associated ones of the plurality of servers based on the login information obtained from the user.

In the above aspects of the present invention, when a user accesses the user interface system for the first time, a registration process is preferably carried out. In the registration process, the user is provided with the first login information (e.g. password) in exchange for providing the system with the further login information that the user possesses for various vendor servers. This further login information is then stored within the user interface system and the user does not need to repeat it.

The user may add further login information to the user interface system as and when they enter relationships with further vendor servers.

In accordance with a fifth aspect of the present invention there is provided a user interface system for interfacing a user with a plurality of vendor servers on a computer network, where a connection to each of the vendor servers is establishable via a protocol involving a login process, the system comprising first login means for allowing access to the system by the user, means for requesting further login information from the user, the further login information comprising a plurality of passwords for associated ones of a plurality of servers, and means for automatically establishing connections between the user and the associated ones of a plurality of servers based on the further login information obtained from the user.

Once the further login information has been entered by the user it may be stored in a database so that the user need not be required to provide the further login information in the future. In an alternative embodiment, however, the user may be requested for the further login information each time they use the system.

The system of this aspect of the invention may include any or all of the features of the system of the first aspect of the invention discussed above.

In accordance with a sixth aspect of the present invention there is provided a method of interfacing a user with a plurality of vendor servers on a computer network, wherein a connection to each of the vendor servers is establishable via a protocol involving a login process, comprising the steps of providing a user interface service, the user interface service requiring a first login password to enable a user to access the service, requesting further login information from the user, the further login information comprising a plurality of passwords for associates ones of the plurality of servers, and establishing connections between the user and the associated ones of the plurality of servers based on the further login information obtained from the user.

In accordance with a seventh aspect of the present invention there is provided a computer program element comprising computer program code means arranged to instruct a computer for interfacing a user with a plurality of vendor servers on a computer network, wherein a connection to each of the servers is establishable via a protocol involving a login process, to:

allow access to the system by the user through a login means

request further login information from the user, the login information comprising a plurality of passwords for associated ones of the plurality of servers; and

establish connections between the system and the associated ones of the plurality of servers based on the login information obtained from the user.

In accordance with an eighth aspect of the present invention there is provided a computer readable medium having a program recorded thereon, wherein the program is arranged to instruct a computer for interfacing a user with a plurality of vendor servers on a computer network, wherein a connection to each of the servers is establishable via a protocol involving a login process, to:

allow access to the system by the user through a login means

request further login information from the user, the login information comprising a plurality of passwords for associated ones of the plurality of servers; and

establish connections between the system and the associated ones of the plurality of servers based on the login information obtained from the user.

As discussed above, in order to maintain a connection between a vendor server and a user's browser, login requests will be initiated by the vendor server periodically so that the user has to re-enter login information.

In accordance with a ninth aspect of the present invention, there is provided a user interface system for maintaining a connection between a user and a vendor server on a computer network, wherein the connection is establishable and maintainable through a protocol involving a login process, the user interface system including maintenance means for automatically responding to a maintenance login request initiated by a vendor server after a period of connection time, wherein the maintenance means is arranged to base the response on login information for the vendor server associated with the user and stored in a database of the user interface system.

The user interface system of this aspect of the invention may include the features of the user interface system of the first and fifth aspects of the present invention in order to facilitate a connection between a plurality of vendor servers and a user.

In accordance with a tenth aspect of the present invention there is provided a method of maintaining a connection between a user and a vendor server on a computer network, wherein the connection is establishable and maintainable through a protocol involving a login process, the method comprising the steps of storing login information for the vendor server and associated with the user in a user interface system, and automatically responding to a maintenance login request initiated by the vendor server after a period of connection time to maintain the connection based on the stored login information.

In accordance with an eleventh aspect of the present invention, there is provided a computer program element including computer program code means arranged to instruct a computer to operate as a user interface system for maintaining a connection between a user and a vendor server on a computer network, wherein the connection is establishable and maintainable through a protocol involving a login process, the computer program code means being arranged to instruct the computer to provide a maintenance means for automatically responding to a maintenance login request initiated by the vendor server after a period of connection time, and to store login information for the vendor server associated with the user in a database of the computer, the maintenance means being arranged to base the response on the stored login information.

In accordance with a twelfth aspect of the present invention there is provided a computer readable medium having program instructions recorded thereon, the program instructions being arranged to instruct a computer to operate as a user interface system for maintaining a connection between a user and a vendor server on a computer network, wherein the connection is establishable and maintainable through a protocol involving a login process, the program instructions being arranged to instruct the computer to store login information for the vendor server associated with the user and to automatically respond to a maintenance login request initiated by the vendor server after a period of connection time, basing the response on the stored login information.

Features and advantages of the present invention will become apparent from the following description of embodiments thereof, by way of example and, with reference to the accompanying drawings, in which:

### BRIEF DESCRIPTION OF THE DRAWINGS

FIG. 1 is a schematic diagram illustrating a system embodying the present invention,

FIG. 2 shows a screen shot from a system in accordance with an embodiment of the present invention,

FIG. 3 shows another screen shot from a system embodying the present invention,

FIG. 4.shows another screen shot from a system in accordance with an embodiment of the present invention, and

FIG. 5 shows a further screen shot from a system in accordance with an embodiment of the present invention.

### DETAILED DESCRIPTION OF THE PREFERRED EMBODIMENTS

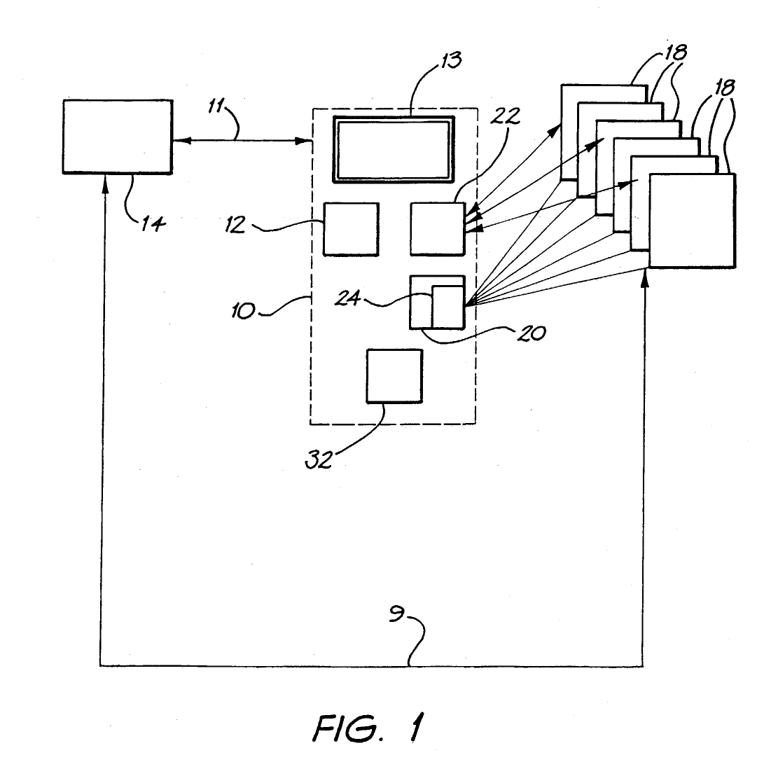

Referring to FIG. 1, a user interface system in accordance with an embodiment of the present invention will now be described. In this description, an example is given of use of the user interface system in connecting to stockbrokers' vendor servers to provide financial content to a user (e.g. share information, company information, financial reports). Levels of security are usually required for such information as the information would usually be bought at a price (although some information may be “open” i.e. available without payment). It will be appreciated, however, that the user interface system of the present invention may be used to provide connections to vendor servers providing any type of content, not only financial content.

FIG. 1 is in schematic form. It will be clear to a skilled person, however, that the blocks illustrated in the diagram are intended to be indicative of computer utilities, e.g. computer servers and user computers. Further, it will also be appreciated that the functionality described in the following description is implementable by way of appropriate computer hardware and software as will be understood by a skilled person.

In the embodiment illustrated in FIG. 1, the user interface system is in the form of a server computing system 10 (which will hereinafter be termed “content server”). A user utilising a browser 14 (which, it will be understood, will be available on a user computing system, e.g. a PC) establishes a one-to-one connection 11 to the content server 10 via a login process. The login process may be a standardised type login process, involving the user browser 14 accessing an interactive website 13 provided by the content server 10 and entering an appropriate password. The content server 10 then authenticates the password and enables a one-to-one connection 11. The password may be any type of user identification e.g. PIN, other ID numbers, retinal identification, fingerprint identification and any other type of ID and any combination of these. If it is the first time that the user has used the system 10, a secure process may be undertaken in order to enable the user to choose a password to enable one-to-one connection 11. This secure process may be implemented outside of the computer network (e.g. by a user physically attending an office, or by any other secure route).

After the one-to-one connection 11 between the browser 14 and the content server 10 has been established, if this is the first time that the user has accessed the system the content server then requests the provision of further login information from the user via the interactive website 13 of the content server 10.

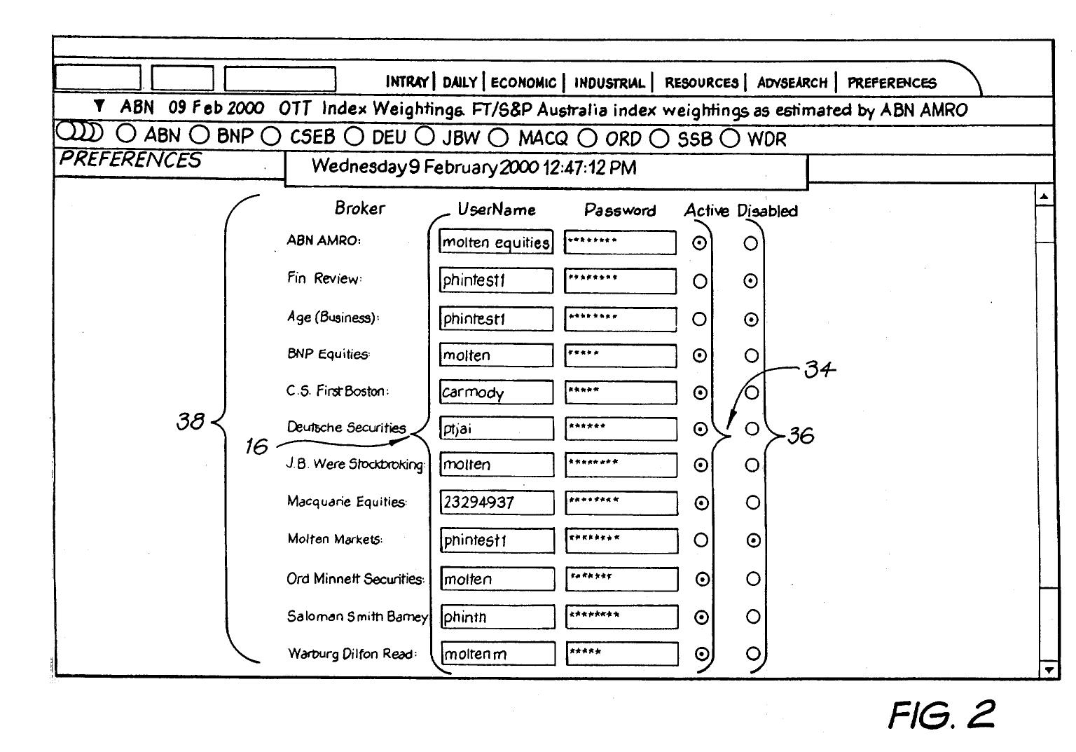

FIG. 2 shows a screen shot of the interactive website 13 showing fields 16 for enabling input of the further login information comprising a plurality of passwords input in respective ones of the field 16. The fields 38 list brokers that the user has entered the passwords to enable connection to.

Referring again to FIG. 1, the further login information is requested with a view to establish a plurality of virtual one-to-one connections between the browser 14 and a plurality of vendor servers 18. In the diagram, the vendor servers are illustrated schematically as blocks. It will be appreciated that each vendor server will comprise appropriate computing hardware and software to enable the serving function. In this example, as discussed above, the vendor servers 18 are stockbroker servers. Typically, they will be arranged to provide content including financial information, financial reports, analyses of businesses and other information which may be utilised by users to assess the value or potential value of stocks. The content provided by the servers may require payment for the content, hence the need for secure access to the vendor servers 18. The servers 18 may also implement several levels of security (e.g. some users will be able to obtain more information than others depending on their security rating). The further login information provided by the user to the content server 10 enables access to the content provided by the vendor servers 18.

In this embodiment, the further login information provided by the user is authenticated by the content server 10. The authentication involves comparison of each of the passwords for associated ones of the servers 18 with authentication data stored in the database 12. In this embodiment, the content server 10 comprises an authentication utility 20. The authentication utility 20 is arranged to encode the passwords obtained from the user and to authenticate them against the authentication data stored in the database 12, which is stored in encoded form. Encoding the authentication data and password prevents hackers and other intruders from breaching security.

The authentication utility 20 comprises a communication utility 24 for receiving the authentication data from the vendor servers 18. Note that the authentication data may be any data which can authenticate the user's access to a server 18 utilising the provided password. The communication utility 24 is arranged to encode the received authentication data and effect storage of the encoded authentication data in the database 12.

When authentication has occurred, a virtual one-to-one connection between the browser 14 and the selected ones of the vendor servers 18 is established. The connection is virtual in the sense that it is not necessarily an actual connection between the browser 14 and the selected vendor servers 18, but rather a “potential” connection. The connection authentication is between content server 10 and the user's browser 14. Content must still be obtained from the vendor servers 18 by a separate process. In this embodiment, this separate process may comprise “browser-based authentication” (which effectively results in a direct connection between the browser 14 and then the server 18 so that the vendor server 18 serves content directly up to the browser 14) or “server-based authentication” (resulting in the content server 10 receiving content from the vendor servers 18 and subsequently serving that up to the browser 14).

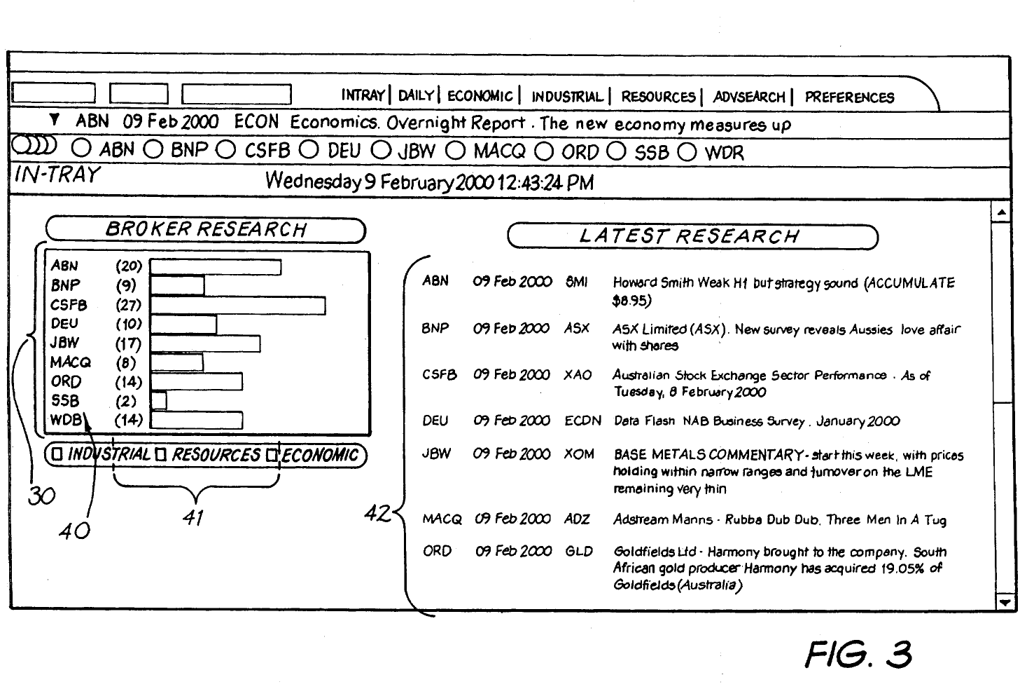

FIG. 3 shows a screen shot which illustrates a screen which appears to the user following successful establishment of the plurality of virtual one-to-one connections between the user browser and the selected ones 30 of the vendor servers. Field 40 lists the brokers and field 41 is a bar graph listing the spread of broker research content that each of the brokers has. Field 42 lists details of the latest research documents provided by each of the brokers 40.

The user may make a number of selections, including selecting a broker to obtain the latest research information for that particular broker, or selecting a latest research document 42 to receive that latest research document.

As discussed above, the content may be provided to the browser 14 in two ways.

In browser based authentication, the client's browser is, firstly, authenticated by the authentication utility 20 as discussed above. Content server 10 then serves metadata to the client's browser. This metadata is in the form of content server links. Clicking on such a link serves the requested URL back to the client's browser via the one-to-one connection 11. The client's browser 14 then establishes a connection 9 directly with the server that is hosting the requested URL address.

In the case of URLs arising from secure servers, content server 10 appends client's authentication details to the URL address, encrypting the URL string and passing the URL string back to the client's browser. The client's browser then passes the encrypted URL string off to the secure server to retrieve the requested document. The secure server 18 receives the authentication details and enables sending of the requested document to the browser 14 by direct link 9.

The alternative method by which content is provided to the browser 14 is via server-based authentication. This is useful where the client's infrastructure (firewall and proxy server) does not permit the content server 10 generated URL string containing the client's usual ID and password details to be successfully passed through to the secure server 18.

In server-based authentication, when the client requests content, content server 10 acts as the client itself by issuing its own request to the vendor server 18 (on behalf of the client). Content server 10 then downloads the document and serves the document back to browser 14. The connection utility 22 in FIG. 1 illustrates the obtaining of content from the vendor servers 18 to be served up to the browser 14 via the interactive website 13.

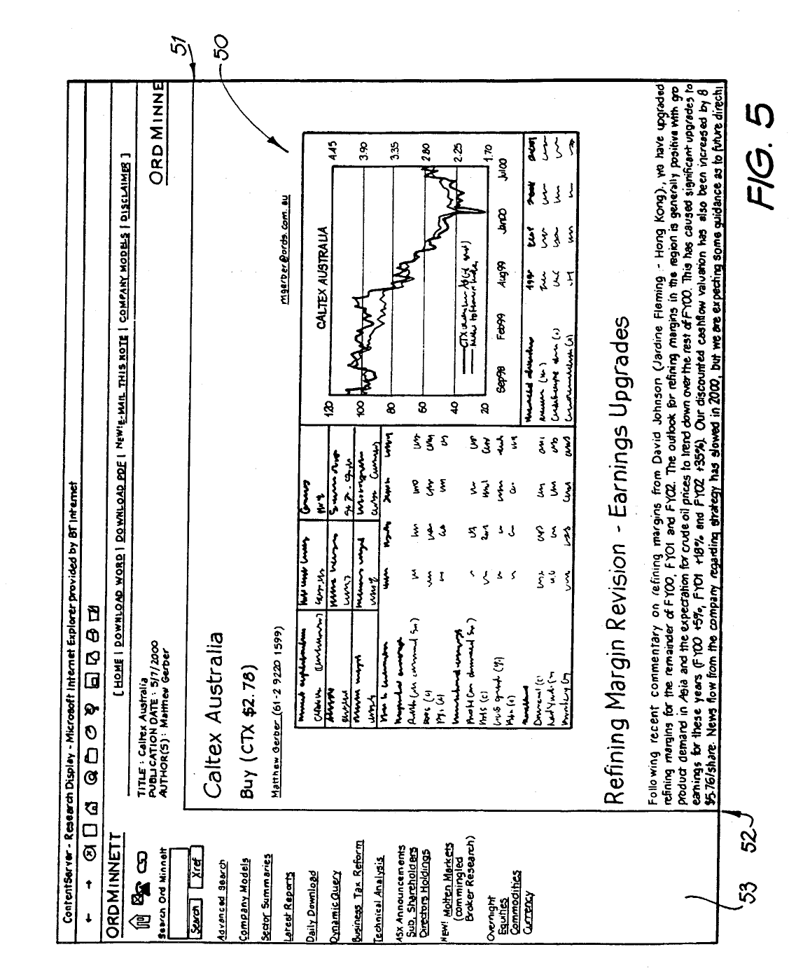

Server-based authentication and browser-based authentication may be combined to enable different types of content to be seamlessly served up to the browser 14 in the same page. FIG. 5 illustrates an example of this. FIG. 5 shows a research document 50 pictured in its own window (boundaries 51, 52) surrounded by “wrapper” 53 pictured in a separate window. The wrapper contains proprietary functionality from the particular broker (i.e. document source) It is convenient for the research document 50 to be served to the browser 14 using server based authentication via content server 10. The proprietary functionality indicated in the wrapper 53, however, is best served via browser based authentication so that the broker server may be accessed to provide full interactive functionality If a user selects a link within the wrapper, the client browser is then prompted for authentication details so the functionality contained in the wrapper can be served (by content server 10 sending an encrypted URL including authentication data to the browser).

In general, more complex types of content such as pages or page sections composed of URLs relating to models and databases located on the source provider a secure site (vendor server) may be more simply and effectively handled by browser-based authentication. This is because the user will be able to gain most value by direct interaction with the functionality on the vendor server, which in turn requires the client browser to establish a direct session with the secure vendor server.

Browser-based and server-based authentication can be used depending on convenience.

Note that the arrangement shown in FIG. 5 is not the only arrangement that could be used to provide a “wrapper” and document content to a user. Different sized and shaped windows may be used to provide both, or the wrapper content may provided on a separate screen. The “wrapper” and document(s) could be provided in grid formation, or any other formation on the screen.

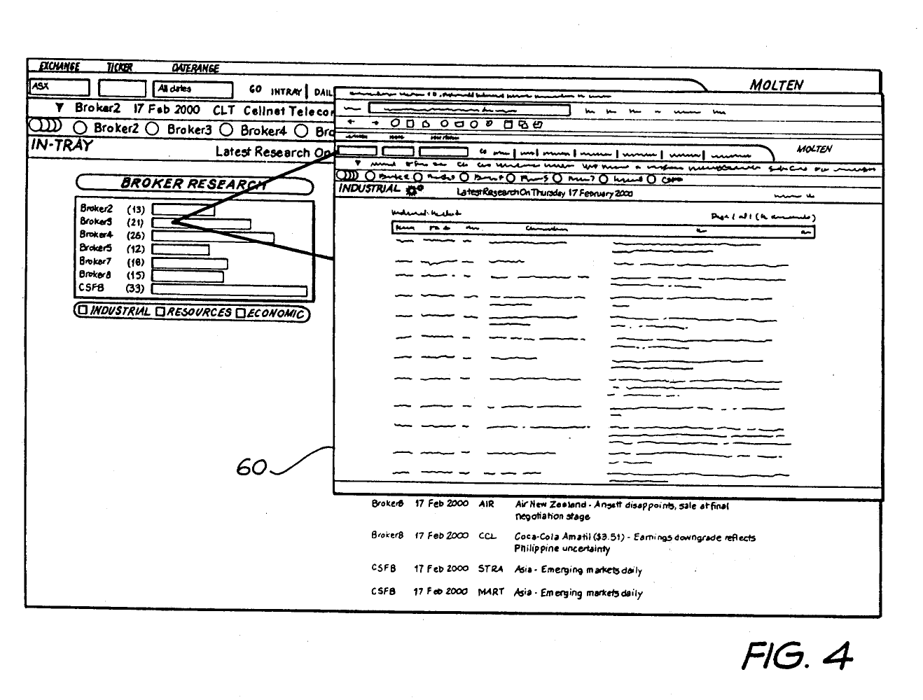

FIG. 4 illustrates a window 6 showing a drilldown feature to an individual broker by sector and product, allowing a listing of all the research documents available for that particular broker.

For security purposes, content providers such as the stockbroker vendor servers discussed above may periodically issue maintenance login requests, requiring a user to go through a further login process in order to maintain the connection. The requirement for a maintenance login process can be inconvenient and difficult, particularly when a user is maintaining a plurality of connections to secure servers.

In the embodiment of FIG. 1 of the present invention, the authentication facilitation utility 20 of content server 10 is arranged to automatically respond to a maintenance login request initiated by a vendor server 18 after a period of connection time.

Accordingly, content server 10 can maintain the virtual one-to-one connection between the browser 14 and the vendor server 18 without any user interaction.

The authentication facilitating utility 20 is arranged to provide the further login information stored in the database 32 in response to the maintenance login request received from the vendor server 18.

The maintenance login process may be carried out utilising the further login passwords provided by the user with the authentication data stored in the database 12 on receipt of a maintenance request from vendor server 18.

Centralised authentication can therefore be achieved without the necessity to centralise administration and maintenance of security policies of the vendor server.

In the embodiment discussed above, on initiation the user of the browser 14 must enter their further login information at the request of the content server 10. Once this login information has been entered, however, it is stored in the second database 32 in encoded form and associated with a login identifier of the user. When the user reconnects to the content server 10, the further login information may automatically be provided in the field 16 of the screen illustrated in FIG. 2. The user may then simply make a selection from the vendor servers for which further login information has already been provided by clicking the appropriate one of the columns fields 34, 36.

As well as providing secure content from vendor servers, the system of the present invention is also able to provide “open” content (content that is not secure). This can be provided directly from content server 10 to browser 14, without requiring any further password login information.

In the above embodiment, the content provided by content server is financial information from vendor servers provided by stockbroking organisations. It will be appreciated that the present invention may be used to provide any type of content to a user. For example, another application is in the health industry, eg serving patient records and other health content to professional users (eg doctors). There are many other applications, as will be appreciated.

Where the terms “server” and “client” have been used in this specification, it will be understood that they are used in the broadest possible sense to include any connection between computing systems where one computing system is providing content to another computing system. This terminology should not be considered to limit the invention to use on the Internet or other conventional computer networks which use server-client relationships.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The claims defining the invention are as follows:

1. A user interface system for interfacing a user with a plurality of vendor servers on a computer network, wherein a connection to each of the vendor servers is establishable via a protocol involving a login process, the system comprising first login means for allowing access to the system by the user, means for storing further login information, the further login information comprising a plurality of passwords for associated ones of a plurality of servers, and means for automatically establishing connections between the user and the associated ones of the plurality of servers based on the stored login information.

2. A system in accordance with claim 1, wherein the means for automatically establishing the connection is arranged, in a first mode of operation, to establish the connection by requesting content from the vendor server and, after that content has been received, subsequently serving the content to the user system.

3. A system in accordance with claim 1 or claim 2, wherein the means for automatically establishing the connection is arranged, in a second mode of operation, to establish the connection by providing to a user computer system a connection means which includes a content identifier, the user computer system subsequently employing the connection means to connect directly to the vendor server to download the identified content.

4. A system in accordance with claim 3, wherein the content identifier also includes an authentication identifier for authenticating the user computer system with the vendor server.

5. A system in accordance with claim 3 or claim 4 when read onto claim 2, the means for automatically establishing the connection being arranged to operate in the first mode of operation or the second mode of operation in dependence upon the type of content to be delivered to the user.

6. A system in accordance with claim 5, including display organisation means for organising a display of content to be provided by the user computing system, the display organisation means being arranged to provide a window including content requested by a user from a vendor server and a further window including details of further content available from the vendor server.

7. A system in accordance with claim 6, wherein if the user selects further content from the further window, the further content is delivered using the second mode of operation of the means for automatically establishing the connection.

8. A system in accordance with claim 6.or claim 7, wherein the content included in the window is delivered by the means for automatically establishing the connection operating in the first mode of operation.

9. A system in accordance with any one of claims 3 to 8, wherein the connection means includes a universal resource locater (URL) as the content identifier.

10. A system in accordance with any one of claims 3 to 9, wherein the authentication identifier includes the user login information for the vendor server.

11. A system in accordance with any one of the preceding claims, including maintenance means for automatically responding to a maintenance login request initiated by a vendor server after a period of connection time, the maintenance means being arranged to base the response to the maintenance login request on the stored login information, whereby to maintain connection.

12. A system in accordance with any one of the preceding claims, wherein the system further comprises means for authenticating the plurality of passwords on the basis of authentication data stored in a database of the system.

13. A system in accordance with claim 12, wherein the means for authenticating comprises means for encoding each of the passwords for comparison with associated encoded authentication data stored in the database of the system.

14. A system in accordance with claim 12 or claim 13, wherein the system further comprises means for receiving the authentication data for the vendor servers for storage in the database.

15. A system in accordance with claim 14, wherein the means for receiving the authentication data is arranged to encode uncoded authentication data received from the vendor servers and to store the encoded authentication data in the database.

16. A system in accordance with any one of the preceding claims, wherein the system is arranged to store the plurality of passwords in encoded form.

17. A method of interfacing a user with a plurality of vendor servers on a computer network, wherein a connection to each of the vendor servers is establishable via a protocol involving a login process, comprising the steps of providing a user interface service, the user interface service requiring a first login password to enable a user to access the service, storing further login information by the user interface service, the further login information comprising a plurality of passwords for associated ones of the plurality of servers, and establishing connections between the user and the associated ones of the plurality of the servers based on the stored login information.

18. A method in accordance with claim 17, wherein the step of establishing a connection between a user system and a vendor server includes the step of the user interface service first establishing a connection between the vendor server and the user interface service to download desired content, and subsequently the user interface service establishing a connection with the user system to download the content to the user system.

19. A method in accordance with claim 17 or claim 18, wherein the step of establishing the connection between a user system and the vendor server includes the step of the user interface service providing a connection means to the user system, the user system subsequently employing the connection means to connect directly to the vendor server to download the desired content.

20. A method in accordance with claim 19, wherein the connection means includes a content identifier and an authentication identifier.

21. A method in accordance with claim 20, wherein the authentication identifier includes the password associated with the user for the particular vendor server

22. A computer program element including computer program code means arranged to instruct a computer to operate as a user interface system for interfacing the user with a plurality of vendor servers on a computer network, where a connection to each of the vendor servers is establishable via a protocol involving a login process, a computer program code means instructing the computer to allow access to the system by the user through a first login means, to store further login information, the further login information comprising a plurality of passwords for associated ones of the plurality of servers, and establish connections between the system and the associated ones of the plurality of servers based on the stored login information.

23. A computer readable medium having instructions recorded thereon for instructing a computer to operate as a user interface system for interfacing a user with a plurality of vendor servers on a computer network, where a connection to each of the servers is establishable via a protocol involving a login process, the instructions being arranged to instruct the computer to allow access to the user interface system by the user through a login means, to store further login information, the further login information comprising a plurality of passwords for associated ones of the plurality of servers, and to establish connections between the system and the associated ones of the plurality of servers based on the login information obtained from the user.

24. A user interface system for interfacing a user with a plurality of vendor servers on a computer network, where a connection to each of the vendor servers is establishable via a protocol involving a login process, the system comprising first login means for allowing access to the system by the user, means for requesting further login information from the user, the further login information comprising a plurality of passwords for associated ones of a plurality of servers, and means for automatically establishing connections between the user and the associated ones of the plurality of servers based on the further login information obtained from the user.

25. A method of interfacing a user with a plurality of vendor servers on a computer network, wherein a connection to each of the vendor servers is establishable via a protocol involving a login process, comprising the steps of providing a user interface service, the user interface service requiring a first login password to enable a user to access the service, requesting further login information from the user, the further login information comprising a plurality of passwords for associates ones of the plurality of servers, and establishing connections between the user and the associated ones of the plurality of servers based on the further login information obtained from the user.

26. A computer program element comprising computer program code means arranged to instruct a computer for interfacing a user with a plurality of vendor servers on a computer network, wherein a connection to each of the servers is establishable via a protocol involving a login process, to:
allow access to the system by the user through a login means
request further login information from the user, the login information comprising a plurality of passwords for associated ones of the plurality of servers; and
establish connections between the system and the associated ones of the plurality of servers based on the login information obtained from the user.

27. A computer readable medium having a program recorded thereon, wherein the program is arranged to instruct a computer for interfacing a user with a plurality of vendor servers on a computer network, wherein a connection to each of the servers is establishable via a protocol involving a login process, to:
allow access to the system by the user through a login means
request further login information from the user, the login information comprising a plurality of passwords for associated ones of the plurality of servers; and
establish connections between the system and the associated ones of the plurality of servers based on the login information obtained from the user.

28. A user interface system for maintaining a connection between a user and a vendor server on a computer network, wherein the connection is establishable and maintainable through a protocol involving a login process, the user interface system including maintenance means for automatically responding to a maintenance login request initiated by a vendor server after a period of connection time, wherein the maintenance means is arranged to base the response on login information for the vendor server associated with the user and stored in a database of the user interface system.

29. A method of maintaining a connection between a user and a vendor server on a computer network, wherein the connection is establishable and maintainable through a protocol involving a login process, the method comprising the steps of storing login information for the vendor server and associated with the user in a user interface system, and automatically responding to a maintenance login request initiated by the vendor server after a period of connection time to maintain the connection based on the stored login information.

30. A computer program element including computer program code means arranged to instruct a computer to operate as a user interface system for maintaining a connection between a user and a vendor server on a computer network, wherein the connection is establishable and maintainable through a protocol involving a login process, the computer program code means being arranged to instruct the computer to provide a maintenance means for automatically responding to a maintenance login request initiated by the vendor server after a period of connection time, and to store login information for the vendor server associated with the user in a database of the computer, the maintenance means being arranged to base the response on the stored login information.

31. A computer readable medium having program instructions recorded thereon, the program instructions being arranged to instruct a computer to operate as a user interface system for maintaining a connection between a user and a vendor server on a computer network, wherein the connection is establishable and maintainable through a protocol involving a login process, the program instructions being arranged to instruct the computer to store login information for the vendor server associated with the user and to automatically respond to a maintenance login request initiated by the vendor server after a period of connection time, basing the response on the stored login information.
